(19) United States
(12) Patent Application Publication
(10) Pub. No.: US 2012/0136507 A1
(43) Pub. Date: May 31, 2012

(54) System and Method for Controlling a Machine at a Worksite

(75) Inventors: Bryan James Everett, Peoria, IL (US); Craig Lawrence Koehrsen, East Peoria, IL (US); Andrew Joseph Vitale, Peoria, IL (US)

(73) Assignee: Caterpillar Inc.

(21) Appl. No.: 12/957,023

(22) Filed: Nov. 30, 2010

(51) Int. Cl. G06F 7/00; G05D 1/00

(52) U.S. Cl. 701/2

(57) ABSTRACT

A system for controlling operation of at least one machine at a worksite includes controls operable under the control of a first entity to operate a first machine to perform one or more tasks at the worksite. The system may also include a portable communication device having a user interface operable to receive a machine-stop command from a second entity. The portable communication device may be operable to transmit a machine-stop signal in response to receiving the machine-stop command from the second entity. The system may also include at least one information processor configured to stop the first machine in response to the transmission of the machine-stop signal from the portable communication device.

### TECHNICAL FIELD

The present disclosure relates to systems and methods for controlling a machine at a worksite and, more particularly, to systems and methods for controlling a machine in the presence of a person at the worksite.

### BACKGROUND

Many commercial endeavors involve operating one or more machines at a worksite to perform various tasks. For example, many construction projects involve operating one or more hauling machines, excavators, earthmovers, compacting machines and the like at a worksite. Often, one or more people may work on foot at the worksite in the midst of such machines. On such a worksite, the people on foot may sometimes become undesirably close to a moving machine. In such circumstances, it may be desirable to stop the machine.

U.S. Pat. No. 6,285,925 B1 to Steffen (“the '925 patent”) discusses a system for automatically stopping a compacting machine. The system disclosed by the '925 patent includes a remote control device held by a person for remotely controlling navigation of the compacting machine. The remote control device of the '925 patent includes provisions for sensing a distance between the remote control device and the compacting machine. If the remote control device senses that the machine is within a certain distance of the remote control device, the remote control device automatically stops the compacting machine.

Although the '925 patent discloses automatically stopping a compacting machine when it gets within a certain distance of a remote control device, certain disadvantages may persist. For example, the system of the '925 patent may not address situations where a person other than an individual remotely controlling a machine may become undesirably close to the machine.

The system and methods of the present disclosure may help address these disadvantages.

### SUMMARY OF THE INVENTION

One disclosed embodiment relates to a system for controlling operation of at least one machine at a worksite. The system may include controls operable under the control of a first entity to operate a first machine to perform one or more tasks at the worksite. The system may also include a portable communication device having a user interface operable to receive a machine-stop command from a second entity. The portable communication device may be operable to transmit a machine-stop signal in response to receiving the machine-stop command from the second entity. The system may also include at least one information processor configured to stop the first machine in response to the transmission of the machine-stop signal from the portable communication device.

Another embodiment relates to a system for controlling one or more mobile machines, the one or more mobile machines including a first mobile machine. The system may include at least one information processor operable to control autonomous navigation of the first mobile machine, the at least one information processor being a first entity. The system may also include a portable communication device that includes a user interface operable to receive a machine-stop command from a second entity. The portable communication device may be operable to transmit a machine-stop signal to the at least one information processor in response to receiving a machine-stop command from the second entity. The at least one information processor may be operable to stop the first mobile machine in response to receiving the machine-stop signal from the portable communication device.

A further disclosed embodiment relates to a method of controlling a machine at a worksite. The method may include operating the machine to perform one or more tasks under the control of a first entity. The method may also include operating a portable communication device at the worksite under the control of a second entity, including selectively transmitting a machine-stop command from the second entity to the portable communication device. Additionally, the method may include, in response to the second entity communicating the machine-stop command to the portable communication device, transmitting a machine-stop signal from the portable communication device to at least one information processor and stopping the machine with the at least one information processor.

### BRIEF DESCRIPTION OF THE DRAWINGS

FIG. 1 shows one embodiment of a system according to the present disclosure;

FIG. 2 shows the exterior of one embodiment of a portable communication device according to the present disclosure;

FIG. 3 shows components contained within an interior of the portable communication device shown in FIG. 2;

FIG. 4 schematically illustrates different operating states that a portable communication device according to one embodiment of the present disclosure may have.

### DETAILED DESCRIPTION

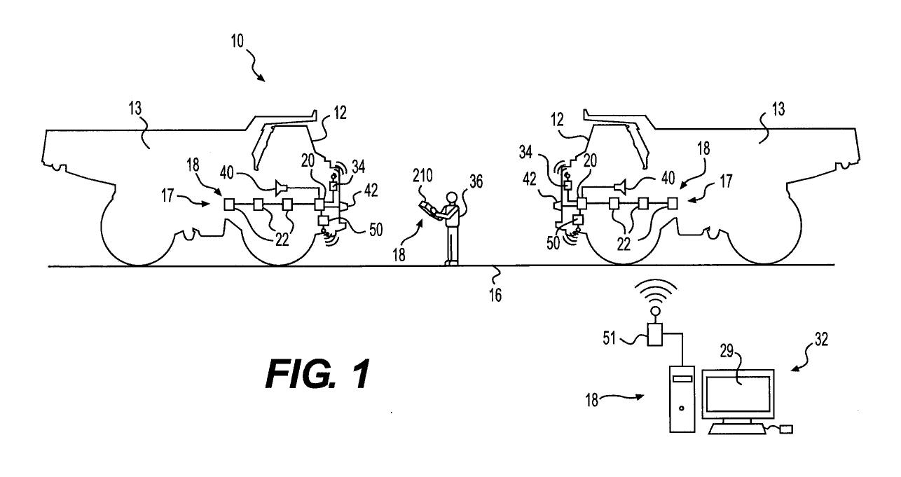

FIG. 1 illustrates one embodiment of a system 10 according to the present disclosure for monitoring and/or controlling operation of one or more machines, such as machines 12, at a worksite 16. Machines 12 may be configured to perform a variety of tasks. For example, machines 12 may be mobile machines configured to transport or move people, goods, or other matter or objects. Additionally, or alternatively, machines 12 may be configured to perform a variety of other operations associated with a commercial or industrial pursuit, such as mining, construction, energy exploration and/or generation, manufacturing, transportation, and agriculture. In the example shown in FIG. 1, machines 12 are shown as mobile machines, specifically hauling machines with dump bodies 13 configured to haul bulk material, such as soil, at worksite 16. In other embodiments, one or more of machines 12 may be an excavator, an earthmoving machine, a compactor, or any other type of machine operable to perform one or more tasks at worksite 16. In addition to machines 12, there may be other machines operating at worksite 16.

Machines 12 may include controls 17 operable to control the operation of machines 12. For instance, where machines 12 are hauling machines as shown in FIG. 1, controls 17 of machines 12 may include controls for controlling propulsion, braking, and steering of machines 12. Machines 12 may also include controls for controlling operation of other systems and implements of machines 12, such as for controlling operation of dump bodies 13 or other implements of machines 12. Controls 17 may be configured to allow control of various aspects of the operation of machines 12 under the control of various entities. For example, in some embodiments controls 17 may be configured to provide fully or partially autonomous control of machines 12 with or without input from off-board components. Additionally, or alternatively, controls 17 may be configured to allow control of one or more aspects of the operation of machines 12 by one or more persons on machines 12 and/or by one or more persons communicating remotely with machines 12.

System 10 may include any component or components operable to monitor and/or control one or more aspects of the operation of machines 12 at worksite 10. For example, system 10 may include one or more information processors 18 that monitor and/or control operation of machines 12 at worksite 16. These information processors 18 may include one or more information processors 18 that are mounted onboard machines 12 and form part of controls 17 of machines 12.

In the embodiment shown in FIG. 1, the information processors 18 forming part of the controls of machines 12 may include a main control module 20 and a plurality of sub-control modules 22 communicatively linked to one another. Each of sub-control modules 22 may be configured to control one or more subsystems of machine 12, and main control module 20 may be configured to coordinate control of those subsystems by sub-control modules 22. For example, sub-control modules 22 may be configured to control the propulsion system, the braking system, and the steering system of machines 12, and main control modules 20 may be configured to coordinate control of these systems by sub-control modules 22. Each of control modules 20, 22 may include any configuration of components operable to perform the methods discussed below. In some embodiments, each control module 20, 22 may include one or more microprocessors and/or one or more memory devices programmed to perform the methods discussed below.

System 10 may also include one or more information processors 18 located off-board machines 12. For example, system 10 may include a remote computer terminal 32 for monitoring, managing, analyzing, and/or controlling one or more aspects of the operation of machines 12. Remote computer terminal 32 may include one or more general-purpose or special-purpose computers from which individuals can monitor and manage one or more aspects of the operation of machines 12. These computers may include one or more memory devices and one or more microprocessors. Remote computer terminal 32 may include a user interface 29 through which remote computer terminal 32 may receive information from and convey information to a user. Remote computer terminal 32 may be located in various places and operated by various entities to perform various tasks. In some embodiments, remote computer terminal 32 may be located at worksite 16. In other embodiments, remote computer terminal 32 may be maintained remote from worksite 16, such as at an offsite management facility. Remote computer terminal 32 may be used to monitor, and in some cases record, the location and speed of machines 12 at various times, the type of work performed by machines 12 at various times, operating parameters of various systems (such as propulsion, steering, and implement systems) of machines 12 at various times, and various other operating parameters of machines 12.

To enable remote computer terminal 32 to monitor, track, and/or manage various aspects of the operation of machines 12, system 10 may include various components and/or systems that provide information to remote computer terminal 32 regarding one or more aspects of the operation of machines 12. For example, system 10 may include communication links between remote computer terminal 32 and machines 12. The communication links between remote computer terminal 32 and machines 12 may be wireless communication links implemented with a transceiver 51 connected to remote computer terminal 32 and transceivers 50 mounted to machines 12. The transceiver 50 of each machine 12 may be communicatively linked to control modules 20, 22. Transceivers 50 may be operable to transmit any information accessible by the controls 17 of machines 12 to remote computer terminal 32. Such information may include, for example, the travel speed and locations of machines 12, aspects of the operation of the propulsion, braking, and steering systems of mobile machines 12, and the like.

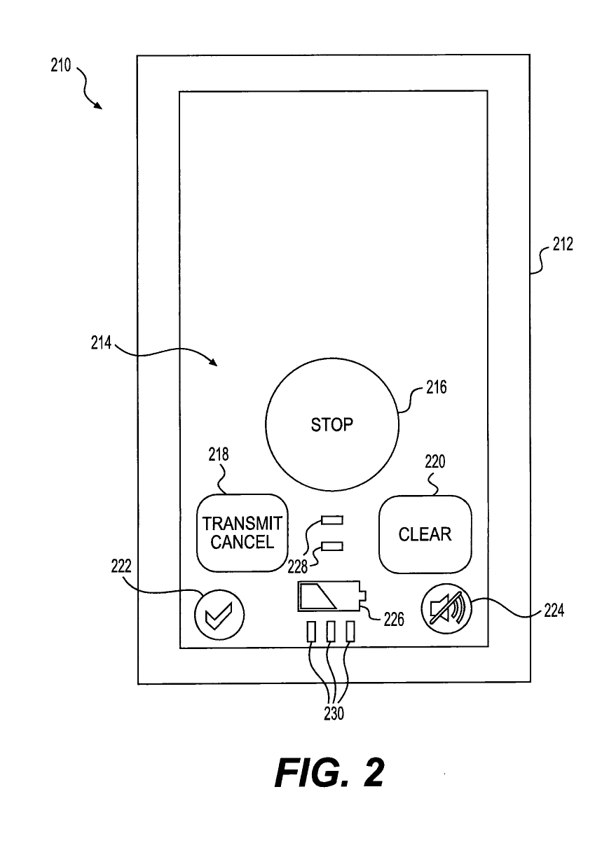

In addition to control modules 20, 22 and remote computer terminal 32, the information processors 18 of system 10 may include a portable communication device 210. Portable communication device 210 may be configured to be carried by a person 36 on foot at worksite 16. In some embodiments, portable communication device 210 may be a handheld device. Portable communication device 210 may be configured to receive a variety of inputs from person 36 and communicate a variety of information to other components of system 10 for a variety of purposes. In some embodiments, portable communication device may be configured to receive a machine-stop command from person 36, indicating that person 36 desires one or more of machines 12 to stop. In response to receiving such a machine-stop command from person 36, portable communication device 210 may be configured to transmit to one or more other components of system 10 a machine-stop signal indicating the desire of person 36 for one or more of machines 12 to stop. The configuration and operation of portable communication device 210 will be discussed in greater detail below in connection with FIGS. 2-4.

System 10 may be operable to monitor and/or control various aspects of the operation of machines 12 at worksite 16. For example, system 10 may be operable to monitor and/or control navigation of machines 12 at worksite 16. To gather information about the location of machines 12 at worksite 16, system 10 may include various sensors and/or components. In some embodiments machines 12 may include global positioning (GPS) modules 34. GPS modules 34 may be communicatively linked to information processors 18 of system 10. For example, GPS modules 34 may be directly communicatively linked to main control modules 20 and indirectly linked to sub-control modules 22 and remote computer terminal 32 through main control modules 20.

In some embodiments, information processors 18 may be configured (i.e., programmed) to control navigation of machines 12 autonomously. To do so, main control modules 20 of machines 12 may, for example, use input from GPS modules 34 to coordinate operation of sub-control modules 22 to control the steering, propulsion, and braking systems of machines 12 to navigate them on desired paths within worksite 16. The desired travel paths for machines 12 may be determined by one or more of information processors 18 and/or one or more persons interacting with information processors 18.

System 10 may also include provisions on machines 12 for signaling to person 36 and/or other persons around machines 12. For example, as FIG. 1 shows, machines 12 may include audio devices 40 (such as horns) for signaling persons around machines 12. Similarly, machines 12 may include lights 42 for visually signaling persons around machines 12. Audio devices 40 and lights 42 may be operably connected to controls 17 of machines 12 in a manner allowing selective activation of audio devices 40 and lights 42 by controls 17.

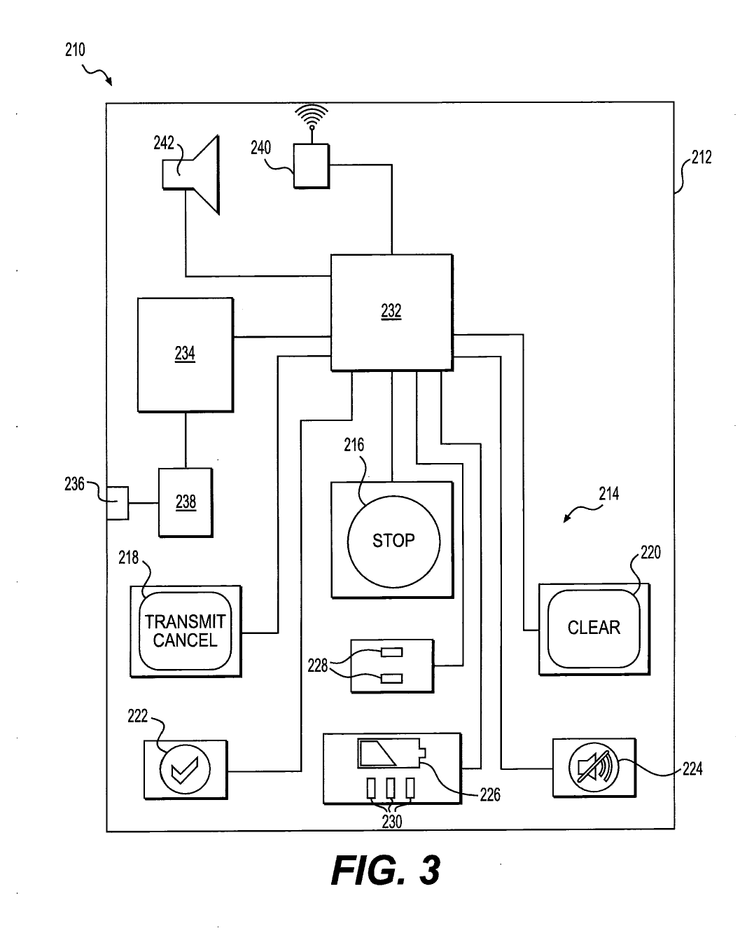

FIGS. 2 and 3 show portable communication device 210 in more detail. Portable communication device 210 may include various components mounted within a housing 212. FIG. 2 provides a schematic illustration of just the exterior of housing 212, and FIG. 3 provides a schematic illustration of the various components contained within housing 212. As best shown in FIG. 3, portable communication device 210 may include a power source 234, an information processor 232, an operator interface 214, a transceiver 240, and an audio device 242. Power source 234 may include any type of component or components operable to provide power to other components of portable communication device 210. For example, power source 234 may include one or more batteries. Transceiver 240 may include any device operable to wirelessly communicate with one or more devices other than portable communication device 210. For example, in some embodiments, transceiver 240 may include an antenna, such as a fixed frequency ISM band antenna. In some embodiments, transceiver 240 may have a limited transmission range, such as 180 to 300 meters. Audio device 242 may include any components operable to emit sounds. For example, in some embodiments, audio device may be a compact, monotone speaker.

Information processor 232 may include any component or components operable to receive information from and/or control one or more aspects of the operation of various other components of portable communication device 210. For example, information processor 232 may include one or more microprocessors and/or one or more memory devices. Information processor 232 may be configured (i.e., programmed) to receive inputs from person 36 through operator interface 214, process those inputs, and control transceiver 240 to transmit signals to other components of system 10. As discussed below, information processor 232 may also be configured to control one or more components of operator interface 214 and/or audio device 242 to provide information back to user 36. To enable information processor 232 to perform these functions, portable communication device 210 may have information processor 232 operatively connected to various components of operator interface 214, to transceiver 240, and to audio device 242.

Operator interface 214 may have provisions for receiving various inputs from person 36 and transmitting information representative of those inputs to other components of portable communication device 210. In some embodiments, operator interface 214 may include provisions with which an operator can communicate a desire to stop one or more of machines 12. For example, operator interface 214 may include a dedicated stop input 216. Stop input 216 may be operatively connected to information processor 232 in a manner allowing stop input 216 to signal information processor 232 when person 36 is activating stop input 216. Thus, by activating stop input 216, person 36 may provide a machine-stop command indicating the desire of person 36 to stop one or more of machines 12.

Operator interface 214 may also include provisions enabling person 36 to communicate when he or she would like to cancel and clear a machine-stop command previously entered. For example, operator interface 214 may include a transmit cancel input 218 and a clear input 220, each communicatively linked to information processor 232. The transmit cancel input 218 may enable person 36 to signal portable communication device 210 that person 36 desires portable communication device 210 to cease transmitting any signals to other components of system 10. Thus, if portable communication device 210 is transmitting a signal implementing a machine-stop command previously made by person 36, person 36 may command portable communication device 210 to stop transmitting the machine-stop command by activating the transmit cancel input 218. The clear input 220 may enable person 36 to communicate a machine-clear command, which may represent an affirmative signal that person 36 wishes to allow resumed operation of any machines 12 that have stopped due to a machine-stop command from person 36.

Operator interface 214 may also include provisions for receiving various other inputs from person 36. For example, operator interface 214 may include provisions with which person 36 can communicate a desire to test the functionality of portable communication device 210 and/or its interaction with other components of system 10. As shown in FIGS. 2 and 3, such provisions may take the form of a test input 222 operatively connected to information processor 232. Additionally, information processor 232 may operate audio device 242 in various circumstances to provide audio signals to person 36. Because person 36 may not desire such audio signals in some circumstances, operator interface 214 may include a mute input 224 with which an operator may communicate a desire to terminate any sounds produced by audio device 242.

Each of the foregoing inputs of operator interface 214 may include any component or components operable to communicate operator inputs in the above-discussed manner. Such components may include switches, buttons, knobs, touch screens, microphones, and the like. In some embodiments, each of the above-discussed inputs may include a switch with a membrane cover on the outside of housing 212 of the portable communication device 210. The membrane cover of each of these inputs may have words or graphics indicating the function of the input. For example, as FIGS. 2 and 3 show the membrane covers of the stop input 216, the transmit cancel input 218, and the clear input 220, may have the words “stop,” “transmit cancel,” and “clear,” respectively, written on them. Similarly, the membrane covers of the test input 222 and the mute input 224 may have icons representative of their functions displayed on them.

Operator interface 214 may also include various components for communicating information to person 36. For example, operator interface 214 may include status indicators 228 for communicating to person 36 the operating state of portable communication device 210. Status indicators 228 may include, for instance, a green light for indicating that portable communication device 210 is operating properly and a red light for indicating a malfunction of portable communication device 210. Additionally, to indicate a state of charge of power source 234, operator interface 214 may include an image 226 of a battery and charge-level indicators 230, such as a series of lights. Status indicators 228 and charge-level indicators 230 may be operatively connected to information processor 232.

Portable communication device 210 may also include various other components. For example, in embodiments where power source 234 is a battery, portable communication device 210 may include provisions for charging power source 234. Such provisions may include a charging port 236 and a charging circuit 238.

Portable communication device 210 may be configured to perform various functions in response to person 36 transmitting commands to portable communication device 210 via operator interface. Information processor 232 of portable communication device 210 may receive signals from operator interface 214 indicative of commands transmitted by person 36. Information processor 232 may be configured (i.e. programmed) to control other components of portable communication device 210 to execute various actions in response to receipt of commands from person 36. Information processor 232 may activate transceiver 240 to relay commands from person 36 to other components of system 10. For example, information processor 232 may activate transceiver 240 to communicate signals to main control modules 20 of machines 12 via transceivers 50 and/or to communicate signals to remote computer terminal 32 via transceiver 51. Main control modules 20 and/or remote computer terminal 32 may be configured to respond to receipt of such information from portable communication device 210 by controlling one or more aspects of the operation of machines 12 in accordance with the commands of person 36. In some embodiments, portable communication device 210 may provide limited control of machines 12 compared to a conventional remote control device. For example, portable communication device 210 may be incapable of controlling navigation of or otherwise mobilizing one or more of machines 12. Operation of portable communication device 210 and system 10 are discussed in more detail below.

Portable communication device 210 is not limited to the configuration discussed above. For example, the inputs of operator interface 214 of portable communication device 210 may have a different configuration. Similarly, operator interface 214 may have provisions for receiving commands other than those discussed above, and/or operator interface 214 may omit one or more of the inputs discussed above. In some embodiments, operator interface 214 may include multiple stop inputs. In such embodiments different stop inputs may be usable by person 36 to communicate a desire to stop different ones or groups of machines 12.

Additionally, system 10 is not limited to the configuration discussed above. For example, system 10 may have different numbers and/or arrangements of information processors 18 communicatively linked to one another in various ways. Also, system 10 may be configured to monitor and/or control the operation of fewer or more machines 12, as well as different kinds of machines than shown in FIG. 1. Similarly, system 10 may include any number of portable communication devices 210 for any number of people that may be present at worksite 16.

### INDUSTRIAL APPLICABILITY

System 10 may have use in any application where one or more people (such as person 36) may be in the presence of one or more machines (such machines 12) on a worksite 16. During operation of system 10, controls 17 of machines 12 may control one or more aspects of the operation of machines 12 under the control of one or more entities other than person 36. For example, sub-control modules 22 may control navigation of machines 12 under the control of main control modules 20 and/or remote computer terminal 32. As noted above, this may include autonomously controlling the navigation of machines 12. Simultaneously, person 36 may perform various tasks among machines 12 at worksite 16, such as monitoring activity of machines 12.

As machines 12 and person 36 perform various tasks at worksite 16, it may become desirable to stop one or more of machines 12 for various reasons. For example, if a machine 12 is moving toward and undesirably close to person 36 and/or another machine 12, stopping one or more of machines 12 may avoid a collision. In many circumstances, person 36 may be in a very good position to identify circumstances where it may be desirable to stop one or more of machines 12. And portable communication device 210 may enable person 36 to communicate to the other information processors 18 of system 10 that person 36 desires one or more of machines 12 to stop.

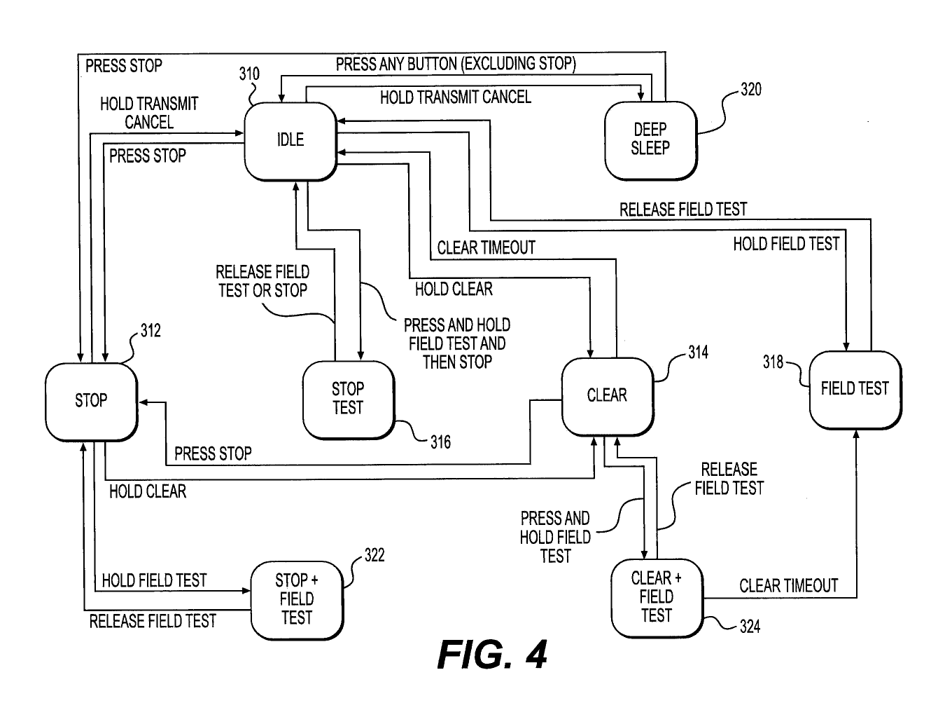

FIG. 4 schematically illustrates one example of how person 36 may use portable communication device 210 to communicate information to other components of system 10. In FIG. 4, each block represents an operating state that portable communication device 210 may have, and the annotated arrows connecting the blocks represent actions that person 36 may take to transition portable communication device 210 between these operating states. The default operating state of portable communication device 210 may be an idle operating state 310.

When portable communication device 210 is in the idle operating state 310, person 36 may request that one or more of machines 12 stop by activating the stop input 216. When information processor 232 receives such a machine-stop command from person 36, information processor 232 may transition portable communication device 210 to a stop operating state 312. As FIG. 4 shows, person 36 may similarly manipulate the stop input 216 to transition portable communication device to the stop operating state 312 from various operating states other than the idle operating state 310, including a clear operating state 314, and a deep sleep operating state 320, which are described in more detail below.

As long as portable communication device 210 remains in the stop operating state 312, information processor 232 may control transceiver 240 to continuously transmit a machine-stop signal encoded to indicate to other information processors 18 to stop one or more of machines 12. In some embodiments, portable communication device 210 may refrain from transmitting any other signals while transmitting a machine-stop signal. The machine-stop signal may be encoded with an identifier unique to portable communication device 210. This may allow any other components of system 10 that receive the machine-stop signal to identify that the signal came from portable communication device 210, rather than other portable communication devices possessed by persons other than person 36. Furthermore, in some embodiments, one or more of the information processors 18 of system 10 may have the name or some other personal identification for person 36 stored in memory and linked to the unique identification of portable communication device 210. This may allow tracking the identity of the person 36 that triggered the machine-stop signal.

In response to portable communication device 210 transmitting a machine-stop signal, system 10 may stop one or more of machines 12. This may take place in a variety of ways. In some embodiments, the transceiver 50 of each machine 12 may be operable to receive the machine-stop signal, such that any machine 12 within the transmitting range of transceiver 240 of portable communication device 210 may receive the machine-stop signal. Additionally, the machine-stop signal from portable communication device 210 and the control modules 20, 22 on machines 12 may be configured such that any machine 12 that receives the machine-stop signal responds by stopping. Thus, system 10 may stop any machine 12 within the transmitting distance of portable communication device 210 when person 36 transmits a machine-stop command using the stop input 216 of portable communication device 210. Alternatively, the machine-stop signal and the control modules 20, 22 on machines 12 may be configured such that only a subset of machines 12, such certain classes or types of machines 12, stop in response to person 36 transmitting a machine-stop command.

System 10 may also monitor such stoppage of one or more machines 12 at remote computer terminal. This may involve the control module 20 of each stopped machine 12 operating transceiver 50 to transmit information about the machine stoppage to remote computer terminal 32. For example, the control module 20 of each stopped machine 12 may communicate that it has stopped the machine 12 in response to a machine-stop signal. Additionally the control module 20 may communicate to remote computer terminal 32 where the machine 12 stopped, and the identity of the portable communication device 210 that transmitted the machine-stop signal triggering the machine stop.

Once one or more machines 12 are stopped as a result of a machine-stop signal from portable communication device 210, system 10 may maintain those machines 12 stopped until certain conditions are met. For example, in some embodiments, system 10 may require that person 36 use portable communication device 210 to communicate a desire to allow reactivation of machines 12 before restarting operation of the machines 12. To communicate such a desire, person 36 may enter a machine-clear command by activating the clear input 220 to transition portable communication device 210 to a clear operating state 314. Person 36 may transition portable communication device 210 directly from the stop operating state 312 to the clear operating state 314 by holding the clear input 220 for two seconds. Alternatively, person 36 may first transition portable communication device 210 back to the idle operating state 310 by holding the transmit cancel input 218 for a period of time (such as two seconds), followed by transitioning portable communication device 210 to the clear operating state 314 by holding the clear input 220 for a period of time (such as two seconds).

Once in the clear operating state 312, portable communication device 210 may transmit a machine-clear signal communicating the intent of person 36 to allow one or more of the stopped machines 12 to resume operation. In some embodiments, portable communication device 210 may continue transmitting the machine-clear signal for a predetermined period of time, such as 30 seconds. Like the machine-stop signal, the machine-clear signal may be encoded with an identifier unique to portable communication device 210, thereby allowing system 10 to distinguish between the machine-clear signal from portable communication device 210 and machine-clear signals from any other portable communication devices possessed by persons at worksite 16 other than person 36.

Various components of system 10 may receive the machine-clear signal transmitted by portable communication device 210. For example, the transceiver 50 of any machine 12 within transmitting range of portable communication device 210 may receive the machine-clear signal and relay the machine-clear signal to the main control module 20 of that machine 12. The machine-clear signal and the main control modules 20 of machines 12 may be configured such that any machine 12 that receives the machine-clear signal from portable communication device 210 has permission from person 36 to resume operation. In such an embodiment, by entering a machine-clear command so that portable communication device 210 transmits a machine-clear signal, person 36 may provide his or her permission to any machine 12 within the transmitting range of portable communication device 210 to resume operation. Alternatively, the machine-clear signal and the main control modules 20 of machines 12 may be configured such that the machine-clear signal provides operating permission from person 36 for only a subset of the nearby machines, such as machines of a certain type or a certain class.

System 10 may also monitor the transmission of machine-clear signals from portable communication device 210 to machines 12. This may involve the main control module 20 of each stopped machine 12 operating transceiver 50 to transmit information about the receipt of a machine-clear signal to remote computer terminal 32. For example, the main control module 20 of each stopped machine 12 may communicate that it has received a machine-clear signal, as well as the identity of the portable communication device 210 that transmitted the machine-clear signal.

System 10 may be configured to permit resumed operation of any stopped machine 12 based solely on receipt of a machine-clear signal from the portable communication device 210 that triggered system 10 to stop the machine 12. Alternatively, system 10 may have additional conditions for allowing a stopped machine 12 to resume operation. For example, in some embodiments, the main control module 20 on each machine 12 may be configured to require a machine-clear signal from remote computer terminal 32, in addition to a machine-clear signal from portable communication device 210. In some embodiments, remote computer terminal 32 may be configured to allow a person operating it to review the situation that resulted in the stoppage of one or more machines 12, evaluate whether it is appropriate to allow resumed operation and, if so, transmit a machine-clear signal from remote computer terminal 32.

Once all the conditions for resuming operation of a stopped machine 12 are met, that stopped machine 12 may continue serving its function at worksite. For example, in cases where a stopped machine 12 is a mobile machine autonomously navigated by the information processors 18 of system 10, the information processors 18 may automatically resume travel of the machine 12. Alternatively, in cases where the machine 12 is controlled by a human operator (either from the machine 12 or remotely) system 10 may release the controls 17 of the machine 12 to resume operation and signal the operator that he or she may resume control of the machine 12.

In addition to the idle operating state 310, the stop operating state 312, and the clear operating state 314, portable communication device 210 may have one or more operating states for testing the functionality of portable communication device 210 and/or its interaction with other components of system 10. For example, portable communication device 210 may have a general field test operating state 318. From the idle operating state 310, person 36 may transition portable communication device 210 to the field test operating state 318 by holding the test input 222 of portable communication device 210, thereby transmitting a test command to portable communication device 210. In some embodiments, the field test operating state 318 may serve the purpose of testing communication between portable communication device 210 and any nearby machines 12. To do so, information processor 232 of portable communication device 210 may activate transceiver 240 to transmit a test signal. The test signal and the main control modules 20 of machines 12 may be configured such that any machine 12 whose transceiver 50 receives the test signal will signal that it has received the test signal. For example, a machine 12 that has received the test signal may activate its audio device 40 and/or its light 42 to acknowledge receipt of the test signal.

In addition to entering the field test operating state 318 directly from the idle operating state 310, it may be possible to enter the field test operating state 318 from the clear operating state 314. When the portable communication device 210 is in the clear operating state 314 and transmitting a machine-clear signal, if person 36 holds the test input 222, portable communication device 210 may enter a clear+field test operating state 324. In this operating state, portable communication device 210 may continue transmitting the machine-clear signal until the predetermined period for doing so ends. While transmitting the machine-clear signal in the clear+field test operating state, the portable communication device 210 may refrain from transmitting a test signal. However, once the predetermined time period for transmitting the machine-clear signal expires, portable communication device 210 may automatically transition to the field test operating state 318 and transmit a test signal.

In addition to the field test operating state 318, portable communication device 210 may include a stop test operating state 316. The stop test operating state 316 may, for example, serve the purpose of testing both the communicating ability of portable communication device 210 and the operation of the stop input 216 of portable communication device 210. Person 36 may use the stop test operating state 316 to test the functionality of portable communication device 210 before going to worksite 16. For example, person 36 may use the stop test operating state 316 in an office environment in the presence of the remote computer terminal 32.

To transition the portable communication device 210 from the idle operating state 310 to the stop test operating state 316, person 36 may communicate a stop-test command by pressing and holding test input 222 and then pressing stop input 216 within a predetermined time (such as two seconds) of pressing test input 222. If stop input 216 is working properly, this stop-test command will transition portable communication device 210 to the stop test operating state 316, rather than the field test operating state 318. In the stop-test operating state 316, information processor 232 may activate transceiver 240 to transmit a stop-test signal different from the general test signal transmitted in the field test operating state 318. Remote computer terminal 32 may receive this stop-test signal via transceiver 51 and communicate to person 36 that the stop input 216 is working properly and the portable communication device 210 is communicating properly.

As shown in FIG. 4, portable communication device 210 may be configured so that it can enter the stop test operating state 316 only from the idle operating state 310. If person 36 has transitioned portable communication device 210 to the stop operating state 312 and then presses the test input 222, portable communication device 210 may transition to a stop+field test operating state 322. In the stop+field test operating state, portable communication device 210 may operate the same as in the stop operating. state 312, transmitting only a machine-stop signal. In other words, entering a machine-stop command with stop input 216 may preempt subsequent entry of a test command with test input 222.

In addition to the foregoing operating states, portable communication device 210 may have a deep sleep operating state 320. In the deep sleep operating state, portable communication device 210 may conserve energy. Person 36 may transition portable communication device 210 to the deep sleep operating state 320 by holding the transmit cancel input 218 for a period of time, such as six seconds. Additionally, information processor 232 may be configured to transition portable communication device 210 to the deep sleep operating state 320 after portable communication device 210 has been in the idle operating state 310 for an extended period of time. To transition portable communication device 210 from the deep sleep operating state 320 back to the idle operating state 310, person 36 may activate any input of portable communication device 210 other than stop input 216. Additionally, in some embodiments, if person 36 continues holding the input used to transition portable communication device 210 from the deep sleep operating state 320 to the idle operating state 310, portable communication device 210 may transition immediately from the idle operating state 310 to the operating state associated with the activated input.

System 10 may also have provisions for ensuring that each machine 12 has good communication with other communication devices of system 10. In some embodiments, this may involve communication of a monitoring signal (e.g., a watchdog signal or heartbeat) between a machine 12 and one or more other communication devices of system 10. For example, one or more of the control modules 20, 22 of each machine 12 may periodically generate a monitoring signal and trigger transmission of that signal by the transceiver on the machine 12. The control modules 20, 22 of other machines 12 may then receive this signal via their transceivers 50.

Receipt of this monitoring signal by the transceiver 50 and control modules 20, 22 of a machine 12 may validate that the transceiver 50 and the communication link from the transceiver to the control modules 20, 22 are functioning properly to receive signals from other communication devices and transmit those signals to the control modules 20, 22. Thus, this may indicate that the machine 12 would properly receive signals (e.g., machine-stop signals) from portable communication device 210, if such signals are transmitted. Accordingly, if the control modules 20, 22 of one machine 12 receive such a monitoring signal transmitted by another machine 12, the control modules 20, 22 of the receiving machine may allow continued operation of that machine. On the other hand, in some embodiments, if the control modules 20, 22 of a given machine 12 do not receive a monitoring signal from any other source within a predetermined period of time, the control modules 20, 22 may stop that machine 12 until a monitoring signal is received and/or other conditions are met.

Operation of system 10 and portable communication device 210 are not limited to the examples discussed above in connection with FIG. 4. For instance, portable communication device 210 may have other operating states besides those discussed above, and/or portable communication device 210 may lack some of the operating states discussed above. Additionally, the triggers for each of the operating states of portable communication device 210 may be different those discussed above. Similarly, portable communication device 210 may operate differently in one or more of its operating states than discussed above. Additionally, the other information processors 18 of system 10 may respond differently to signals from portable communication device 210 than discussed above. Furthermore, the processes handled by the information processors 18 other than portable communication device 210 may be distributed differently between those information processors 18.

The disclosed system 10 and portable communication device 210 may provide certain benefits. For example, the portable communication device 210 may allow any person in the presence of machines at a worksite to stop one or more of the machines on command. By doing so, such a person may prevent the machines from coming undesirably close to that person, other people, and/or other machines.

It will be apparent to those skilled in the art that various modifications and variations can be made in the disclosed system and methods without departing from the scope of the disclosure. Other embodiments of the disclosed system and methods will be apparent to those skilled in the art from consideration of the specification and practice of the system and methods disclosed herein. It is intended that the specification and examples be considered as exemplary only, with a true scope of the disclosure being indicated by the following claims and their equivalents.

What is claimed is:

1. A system for controlling operation of at least one machine at a worksite, the system comprising:
controls operable under the control of a first entity to operate a first machine to perform one or more tasks at the worksite;
a portable communication device having a user interface operable to receive a machine-stop command from a second entity, wherein the portable communication device is operable to transmit a machine-stop signal in response to receiving the machine-stop command from the second entity; and
at least one information processor configured to stop the first machine in response to the transmission of the machine-stop signal from the portable communication device.

2. The system of claim 1, wherein:
the user interface of the portable communication device is operable to receive a machine-clear command from the second entity;
the portable communication device is configured to transmit a machine-clear signal in response to receiving the machine-clear command from the second entity; and
subsequent to receiving a machine-stop signal from the portable communication device, the at least one information processor is operable to maintain the first machine in a stopped state at least until receipt of a machine-clear signal from the portable communication device.

3. The system of claim 1, wherein the portable communication device is a handheld device.

4. The system of claim 1, wherein:
the user interface of the portable communication device is operable to receive a test command from the second entity; and
the system is configured to test at least one function of the portable communication device and the at least one information processor in response to the second entity transmitting a test command to the portable communication device.

5. The system of claim 1, wherein the at least one information processor includes at least one information processor on the first machine, the information processor on the first machine being configured to receive a machine-stop signal generated by the portable communication device and stop the first machine in response.

6. The system of claim 5, further comprising one or more additional machines, each of the additional machines having at least one information processor configured to stop the machine in response to the portable communication device generating a machine-stop signal.

7. The system of claim 1, wherein the first entity includes the at least one information processor, and the at least one information processor is configured to control the first machine autonomously.

8. The system of claim 1, wherein the second entity is a person.

9. The system of claim 1, wherein:
the first machine is a mobile machine;
the first entity includes the at least one information processor; and
the first entity is configured to autonomously navigate the mobile machine.

10. The system of claim 1, wherein the controls are configured to be operable by a machine operator.

11. The system of claim 1, wherein the first machine is at least one of a hauling machine, an excavator, an earthmoving machine, and a compacting machine.

12. A system for controlling one or more mobile machines, the one or more mobile machines including a first mobile machine, the system comprising:
at least one information processor operable to control autonomous navigation of the first mobile machine, the at least one information processor being a first entity;
a portable communication device that includes a user interface operable to receive a machine-stop command from a second entity, the portable communication device being operable to transmit a machine-stop signal to the at least one information processor in response to receiving a machine-stop command from the second entity; and
wherein the at least one information processor is operable to stop the first mobile machine in response to receiving the machine-stop signal from the portable communication device.

13. The system of claim 12, wherein:
the one or more mobile machines include a plurality of mobile machines;
the at least one information processor includes at least one information processor on each of the plurality of mobile machines, the at least one information processor on each mobile machine being configured to stop the mobile machine in response to receiving the machine-stop command from the portable communication device.

14. The system of claim 13, wherein the portable communication device is configured to transmit the machine-stop command to each of the at least one information processor disposed within a transmitting range of the portable communication device.

15. The system of claim 12, wherein:
the one or more mobile machines includes a plurality of mobile machines; and
the at least one information processor is configured to stop only a subset of the plurality of mobile machines in response to transmission of the machine-stop command from the portable communication device.

16. The system of claim 12, wherein the second entity is a person.

17. A method of controlling a machine at a worksite, the method comprising:
operating the machine to perform one or more tasks under the control of a first entity;
operating a portable communication device at the worksite under the control of a second entity, including selectively transmitting a machine-stop command from the second entity to the portable communication device;
in response to the second entity communicating the machine-stop command to the portable communication device, transmitting a machine-stop signal from the portable communication device to at least one information processor and stopping the machine with the at least one information processor.

18. The method of claim 17, wherein the first entity is the at least one information processor.

19. The method of claim 18, wherein:
the machine is a mobile machine; and
operating the machine to perform one or more tasks includes autonomously navigating the machine.

20. The method of claim 17, wherein the second entity is a person.
